(19) United States
(12) Patent Application Publication
(10) Pub. No.: US 2026/0235192 A1
(43) Pub. Date: Aug. 13, 2026

(54) BALL SCREW ACTUATOR

(71) Applicant: KURODA PRECISION INDUSTRIES LTD., Kawasaki-shi, Kanagawa (JP)

(72) Inventors: Ryo KAIBE, Kanagawa (JP); Tatsuto OMORI, Kanagawa (JP)

(21) Appl. No.: 19/149,377

(22) PCT Filed: Jan. 20, 2023
(86) PCT No.: PCT/JP2023/001727

§ 371 Date: Jul. 18, 2025

(51) Int. Cl. F16H 25/22; F16H 25/20; F16H 57/04

(52) U.S. Cl. CPC F16H 25/2214; F16H 57/0497; F16H 2025/204

(57) ABSTRACT

A ball screw actuator includes: a lubricating oil injection passage provided offset to one of left and right sides with respect to a through hole through which a ball screw shaft passes; and a lubricating oil supply passage for supplying lubricating oil from the lubricating oil injection passage to return passages of left and right linear ball bearings, wherein the lubricating oil supply passage includes a first passage that extends from the lubricating oil injection passage to a branch position on a bilateral symmetry line which passes through a center of the through hole, and second passages which are branched left and right from the branch position to respectively extend to the left and right return passages and are bilaterally symmetric.

### CROSS-REFERENCE TO RELATED APPLICATIONS

This application is the U.S. National Stage entry of International Application No. JP/2023/001727, filed on Jan. 20, 2023, which is hereby incorporated herein by reference in its entirety for all purposes.

### TECHNICAL FIELD

The present invention relates to a ball screw actuator, and more specifically relates to a lubricating oil supply structure for linear ball bearings incorporated in the ball screw actuator.

### BACKGROUND ART

As a linear motion actuator, there is known a ball screw actuator that includes: a linear guide rail including left and right side walls and having a concave cross-sectional shape; a slider disposed between the left and right side walls of the guide rail; left and right linear ball bearings which are provided with multiple balls that circulate between the slider and the left and right side walls of the guide rail, and which guide movement of the slider in an axial direction relative to the guide rail; a ball screw nut part provided in the slider; and a ball screw shaft that passes, in the axial direction, through a through hole provided in the slider at a lateral center and is threadedly engaged with the ball screw nut part provided in the slider via balls (for example, Patent Document 1). The slider provided in the ball screw actuator includes a slider main body holding the ball screw nut part, and ball return members attached to both ends of the slider main body in the axial direction and provided with return passages of the left and right linear ball bearings.

A structure for supplying lubricating oil such as grease to the left and right linear ball bearings of the ball screw actuator mentioned above includes a lubricating oil injection passage provided in each ball return member and a lubricating oil supply passage for supplying the lubricating oil from the lubricating oil injection passage to the return passages of the left and right linear ball bearings (hereinafter may be referred to as the left and right return passages).

### PRIOR ART DOCUMENT(S)

### Patent Document(s)

Patent Document 1: JPH4-115842A

### SUMMARY OF THE INVENTION

### Task to be Accomplished by the Invention

To lubricate the left and right linear ball bearings of the ball screw actuator evenly with each other, it is necessary to supply the lubricating oil to the left and right return passages evenly with each other.

Since the left and right linear ball bearings are provided bilaterally symmetrically with respect to the through hole through which the ball screw shaft passes, if the lubricating oil injection passage which extends in the axial direction is on the bilateral symmetry line which passes through the center of the through hole, the left and right return passages are provided bilaterally symmetrically with respect to the through hole, in other words, the passage lengths from the lubricating oil injection passage to the left and right return passages are the same, whereby the lubricating oil is supplied to the left and right return passages evenly with each other.

However, if the lubricating oil injection passage is provided on the bilateral symmetry line which passes through the center of the through hole, the outer dimension of the slider in the up-down direction (see the height dimension H in FIG. 5) becomes greater than the sum of the diameter of the through hole and the diameter of the lubricating oil injection passage, and downsizing the slider in the up-down direction becomes difficult.

If the lubricating oil injection passage is provided offset to one of left and right sides with respect to the through hole, the outer dimension of the slider in the up-down direction can be made equal to or less than the sum of the diameter of the through hole and the diameter of the lubricating oil injection passage, and the slider can be downsized in the up-down direction. However, in this case, the passage lengths from the lubricating oil injection passage to the left and right return passages are not the same, and it becomes difficult to supply the lubricating oil to the left and right return passages evenly with each other.

A task to be accomplished by the present invention is to supply the lubricating oil evenly to the left and right linear ball bearings even when the lubricating oil injection passage is provided offset to one of left and right sides with respect to the through hole.

### Means to Accomplish the Task

To achieve the above object, one aspect of the present invention provides a ball screw actuator, comprising: a linear guide rail including left and right side walls and having a concave cross-sectional shape; a slider disposed between the left and right side walls of the guide rail; left and right linear ball bearings which are provided with multiple balls that circulate between the slider and the left and right side walls of the guide rail, and which guide movement of the slider in an axial direction relative to the guide rail; a ball screw nut part provided in the slider; and a ball screw shaft that passes through a through hole provided in the slider in the axial direction and is threadedly engaged with the ball screw nut part provided in the slider via balls, wherein the slider comprises a slider main body including a ball screw nut part, and ball return members respectively attached to both ends of the slider main body in the axial direction, at least one of the ball return members includes left and right return passages through which each ball of the left and right linear ball bearings moves, the left and right linear ball bearings being provided bilaterally symmetrically with respect to the through hole, a lubricating oil injection passage provided offset to one of left and right sides with respect to the through hole, and a lubricating oil supply passage for supplying lubricating oil from the lubricating oil injection passage to the left and right return passages, and the lubricating oil supply passage includes a first passage that extends from the lubricating oil injection passage to a branch position on a bilateral symmetry line which passes through a center of the through hole, and second passages which are branched left and right from the branch position to respectively extend to the left and right return passages and are bilaterally symmetric.

According to this aspect, the lubricating oil is supplied evenly to the left and right linear ball bearings (return passages) even when the lubricating oil injection passage is provided offset to one of left and right sides with respect to the through hole.

In the above aspect, preferably, each of the left and right linear ball bearings includes an external passage formed between a corresponding one of the side walls of the guide rail and the slider main body and an internal passage formed to extend in the axial direction inside the slider main body, each of the left and right return passages includes an outer end portion communicating with the corresponding external passage and an inner end portion communicating with the corresponding internal passage, and the second passages respectively communicate with parts of the left and right return passages on a side closer to the outer end portion than to the inner end portion.

According to this aspect, the lubricating oil is supplied to the return passages smoothly without increasing the supply pressure of the lubricating oil.

In the above aspect, preferably, the second passages respectively communicate with the outer end portions of the left and right return passages.

According to this aspect, the lubricating oil is supplied to the return passages even more smoothly without increasing the supply pressure of the lubricating oil.

In the above aspect, preferably, the first passage and the second passage include parts that overlap each other in front and in back in the axial direction, and the first passage and the second passage at the parts that overlap each other are separated by a partition wall provided on the ball return member.

According to this aspect, the parts of the first passage and the second passage that overlap each other in front and in back in the axial direction are configured without interfering with each other.

In the above aspect, preferably, the partition wall is constituted of a partition wall member attached to the ball return member.

According to this aspect, formation of the partition wall becomes easy.

In the above aspect, preferably, the lubricating oil supply passage includes third passages extending from the second passages bilaterally symmetrically on a radially outer side of the through hole, and a fourth passage extending from bilaterally symmetric positions of the third passages to the through hole.

According to this aspect, the lubricating oil is also supplied from the through hole to the ball screw shaft.

In the above aspect, preferably, the first passage, the second passages, the third passages, and the fourth passage include parts constituted of recessed grooves opening in a surface of the ball return member that contacts an end surface of the slider main body, and the recessed grooves define the lubricating oil supply passage with an opening being closed by the end surface of the slider main body.

According to this aspect, a lubricating oil supply passage having a closed cross-sectional shape is easily formed with a high degree of freedom.

In the above aspect, preferably, the first passage and the second passage include parts that overlap each other in front and back in in the axial direction, and the first passage and the second passage at the parts that overlap each other are separated by a partition wall member attached to the ball return member, the part of the second passage overlapping the first passage being constituted of a recessed groove provided in the partition wall member.

According to this aspect, the portion of the second passage that overlaps the first passage is easily formed without interfering with the first passage.

In the above aspect, preferably, the ball screw actuator comprises a seal plate disposed between the slider main body and each of the ball return members, wherein each of the seal plates has an opening with an inner diameter smaller than the through hole.

According to this aspect, the lubricating oil supplied to the through hole of the ball return member is prevented from excessively flowing to the slider main body.

In the above aspect, preferably, each of the left and right linear ball bearings is configured in two stages, an upper stage and a lower stage, the ball return member includes the return passages arranged in two stages, an upper stage and a lower stage, and the second passages extend bilaterally symmetrically to between the return passages arranged in the upper stage and the lower stage and are in communication with the return passages arranged in the upper stage and the lower stage.

According to this aspect, even when the lubricating oil injection passage is offset to one side in the left-right direction with respect to the through hole, supply of the lubricating oil to the left and right linear ball bearings arranged in the upper stage and the lower stage is performed evenly between up and down and between left and right.

### Effect of the Invention

In the ball screw actuator according to the present invention, the lubricating oil is supplied evenly to the left and right linear ball bearings even when the lubricating oil injection passage is provided offset to one of left and right sides with respect to the through hole.

### BRIEF DESCRIPTION OF THE DRAWINGS

FIG. 1 A perspective view showing Embodiment 1 of a ball screw actuator according to the present invention

FIG. 2 An enlarged exploded perspective view of a main part of the ball screw actuator according to Embodiment 1

FIG. 3 A perspective view of a main part of a ball return member of the ball screw actuator according to Embodiment 1

FIG. 4 A perspective view of a main part of a partition wall member of the ball screw actuator according to Embodiment 1

FIG. 5 A front view of the ball return member of the ball screw actuator according to Embodiment 1

FIG. 6 A sectional view taken along line VI-VI in FIG. 5

FIG. 7 A skeleton diagram schematically showing linear ball bearings and lubricating oil passages of the ball screw actuator according to Embodiment 1

FIG. 8 A perspective view showing Embodiment 2 of the ball screw actuator according to the present invention

FIG. 9 A perspective view of a ball return member of the ball screw actuator according to Embodiment 2

FIG. 10 A front view of the ball return member of the ball screw actuator according to Embodiment 2

### MODE(S) FOR CARRYING OUT THE INVENTION

Preferred embodiments of the present invention will be described with reference to the appended drawings.

### Embodiment 1

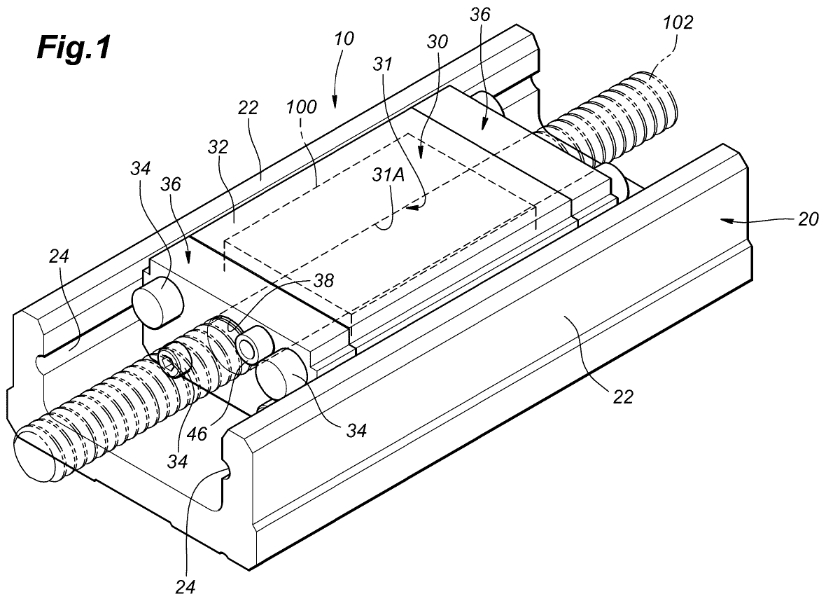

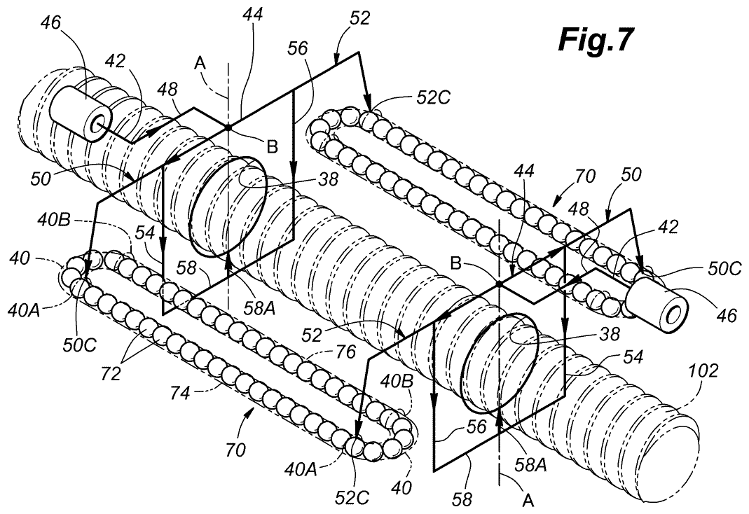

With reference to FIG. 1 to FIG. 7, a ball screw actuator 10 of Embodiment 1 will be described. Note that FIG. 7 is a skeleton diagram which schematically shows ball circulation passages and lubricating oil passages of linear ball bearings and in which illustration of a slider 30 and side walls 22 which are described later is omitted.

As shown in FIG. 1, the ball screw actuator 10 of Embodiment 1 includes a linear guide rail 20 including left and right side walls 22 and having a concave cross-sectional shape, a slider 30 disposed between the left and right side walls 22 of the guide rail 20, and left and right linear ball bearings 70 which are provided with multiple balls 72 (see FIG. 7) that circulate between the slider 30 and the left and right side walls 22 of the guide rail 20 and which guide movement of the slider 30 in an axial direction relative to the guide rail 20.

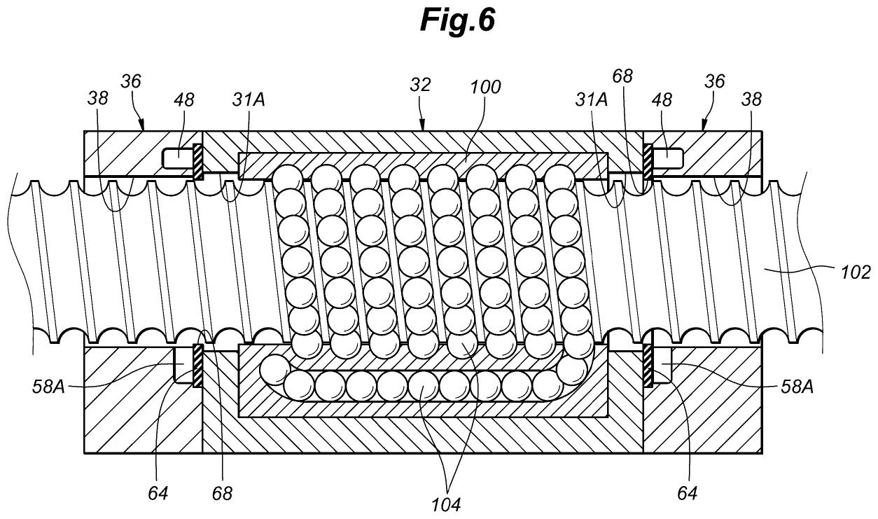

The ball screw actuator 10 further includes a ball screw nut part 100 provided in the slider 30 and a ball screw shaft 102 that passes, in the axial direction, through a through hole 31 provided in the slider 30 and is threadedly engaged with the ball screw nut part 100 provided in the slider 30 via balls 104 (see FIG. 6). The ball screw shaft 102 is rotationally driven by an electric motor attached to an axial end of the guide rail 20 but not shown in the drawings. Note that the ball screw nut part 100 may be configured to be integral with the slider 30.

The slider 30 includes a slider main body 32 including the ball screw nut part 100 and having a substantially rectangular parallelepiped shape, and front and rear ball return members 36 fixed to both ends in the axial direction (front and rear ends) of the slider main body 32 by multiple bolts 34 and each having a substantially rectangular parallelepiped shape.

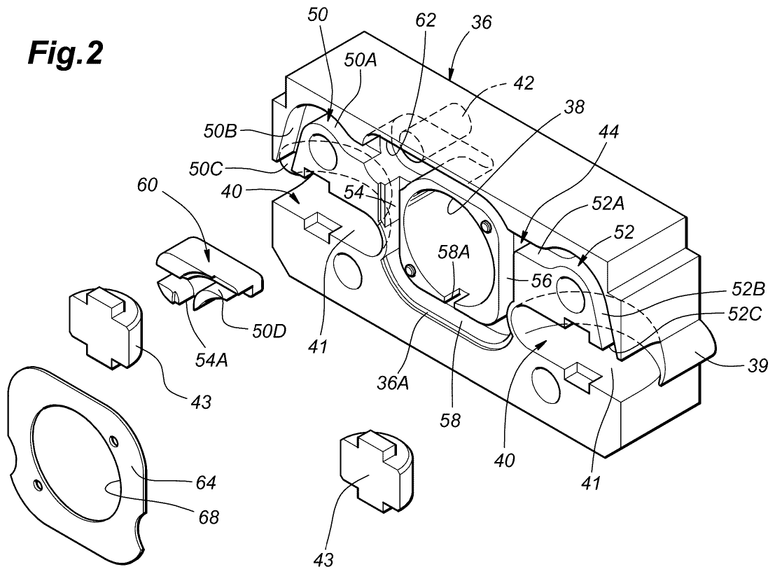

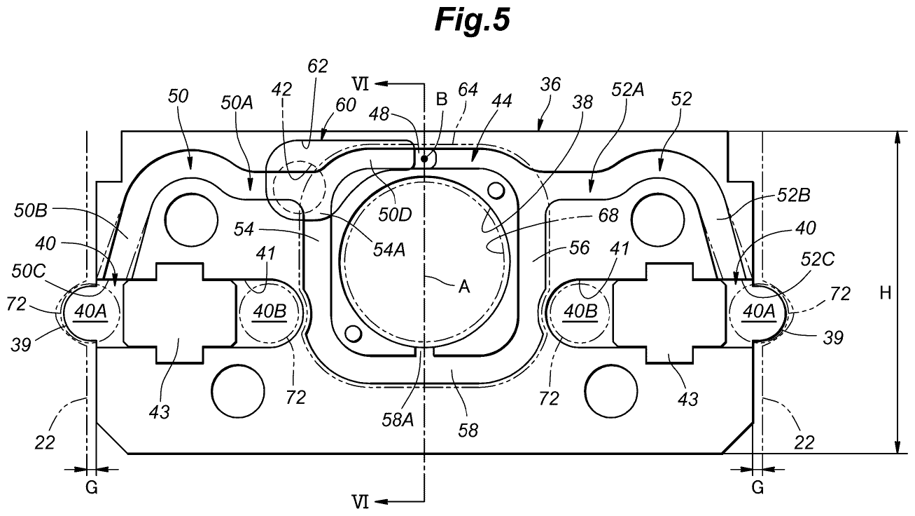

As shown in FIG. 2 and FIG. 5, each ball return member 36 has a through hole 38 that passes through the substantially central part thereof in the axial direction and forms a part of the through hole 31 mentioned above. As shown in FIG. 6, the through hole 38 has an inner diameter substantially the same as or smaller than that of a through hole 31A which is a part of the through hole 31 through which the slider main body 32 passes and is provided substantially on the same axis (substantially coaxially) with the through hole 31A.

Each of the ball return members 36 further includes left and right return passages 40 which are provided bilaterally symmetrically with respect to the through hole 38 and through which each ball 72 of the left and right linear ball bearings 70 rollably moves, a lubricating oil injection passage 42 extending in the axial direction and provided offset to one of left and right sides with respect to the through hole 38, and a lubricating oil supply passage 44 for supplying lubricating oil such as grease from the lubricating oil injection passage 42 to the left and right return passages 40. To an outer wall of each ball return member 36, a lubricating oil nipple 46 (see FIG. 1 and FIG. 7) is attached to communicate with the corresponding lubricating oil injection passage 42.

As shown in FIG. 7 described in detail later, each of the left and right linear ball bearings 70 includes an external passage 74 formed to extend in the axial direction between the corresponding side wall 22 (see FIG. 1) of the guide rail 20 and the slider main body 32 (see FIG. 1) and an internal passage 76 formed to extend (pass through) in the axial direction inside the slider main body 32 (see FIG. 1). Each external passage 74 is formed by a recessed groove 24 (see FIG. 1) formed in the inner side surface of the side wall 22 and having a substantially semicircular cross section and a recessed groove (not shown in the drawings) formed in the outer side surface of the slider main body 32 and having a substantially semicircular cross section. The inner side surface of the side wall 22 and the outer side surface of the slider main body 32 are not in contact with each other, and an air gap G (see FIG. 5) which has a gap width in the left-right direction and extends in the axial direction is formed between the inner side surface of the side wall 22 and the outer side surface of the slider main body 32.

As shown in FIG. 2 and FIG. 5, each of the left and right return passages 40 is a passage defined by a recessed groove 41 formed in the ball return member 36 to have a substantially semicircular planar shape and a passage defining member 43 attached to the ball return member 36 and having a substantially semicircular planar shape such that each return passage 40 has a substantially semicircular (U-shaped) planar shape in which the balls 72 can roll. Each return passage 40 has an outer end portion 40A communicating with the corresponding external passage 74 and an inner end portion 40B communicating with the corresponding internal passage 76.

Each ball return member 36 is formed with ball fall-off preventing parts 39 for preventing the balls 72 of the linear ball bearing 70 from falling off to the outside from the respective outer end portions 40A of the left and right return passages 40, such that the ball fall-off preventing parts 39 each having a substantially semicircular cross-sectional shape protrude outward from the left and right outer walls, respectively.

In each of the left and right linear ball bearings 70, a closed loop circulation path in which multiple balls 72 circulate is constituted of the external passage 74, the internal passage 76, and the front and rear return passages 40 which communicate with each other.

The lubricating oil supply passage 44 includes a first passage 48 which, as seen in FIG. 5 and FIG. 7, extends rightward from the lubricating oil injection passage 42 and extends to a branch position B on a bilateral symmetry line A extending in the up-down direction to pass through the center of the through hole 38, and a left second passage 50 and a right second passage 52 which are branched left and right from the branch position B to respectively extend to the left and right return passages 40 and are bilaterally symmetric.

The left second passage 50 includes a leftward extending part 50A that extends leftward from the branch position B, and an inclined extending part 50B that is bent obliquely downward from the left end of the leftward extending part 50A to extend to the left return passage 40. The inclined extending part 50B includes a communicating end 50C that communicates with the return passage 40 in the vicinity of the left outer end portion 40A.

The communicating end 50C is only required to open at a position of the left return passage 40 on the side closer to the outer end portion 40A than a position where the left return passage 40 is bisected between the inner end portion 40B and the outer end portion 40A. As shown by a virtual line in FIG. 5, preferably, the communicating end 50C is in communication with the return passage 40 at the left outer end portion 40A which is closest to the air gap G of the left external passage 74.

The right second passage 52 includes a rightward extending part 52A that extends rightward from the branch position B, and an inclined extending part 52B that is bent obliquely downward from the right end of the rightward extending part 52A to extend to the right return passage 40. The inclined extending part 52B includes a communicating end 52C that communicates with the return passage 40 in the vicinity of the right outer end portion 40A.

The communicating end 52C is only required to open at a position of the right return passage 40 on the side closer to the outer end portion 40A than a position where the right return passage 40 is bisected between the inner end portion 40B and the outer end portion 40A. As shown by a virtual line in FIG. 5, preferably, the communicating end 52C is in communication with the return passage 40 at the right outer end portion 40A which is closest to the air gap G of the right external passage 74.

The left second passage 50 and the right second passage 52 are bilaterally symmetric with respect to the bilateral symmetry line A, and the passage lengths thereof are the same as each other.

The lubricating oil supply passage 44 further includes a left third passage 54 and a right third passage 56 that bilaterally symmetrically extend in the up-down direction from the left second passage 50 and the right second passage 52 on the radially outer side of the through hole 38, and a fourth passage 58 that extends in the left-right direction and connects lower ends of the left third passage 54 and the right third passage 56 to each other. The fourth passage 58 includes an open end 58A that opens toward a lower portion of the through hole 38 and extends to the through hole 38.

The first passage 48, the left second passage 50, the right second passage 52, the left third passage 54, the right third passage 56, and the fourth passage 58 include parts constituted of recessed grooves opening in the surface of the ball return member 36 that is joined to the end surface of the slider main body 32. With the openings being closed by the end surface of the slider main body 32, the recessed grooves define a lubricating oil supply passage having a closed cross-sectional shape. This facilitates configuration of a lubricating oil supply passage with a high degree of freedom.

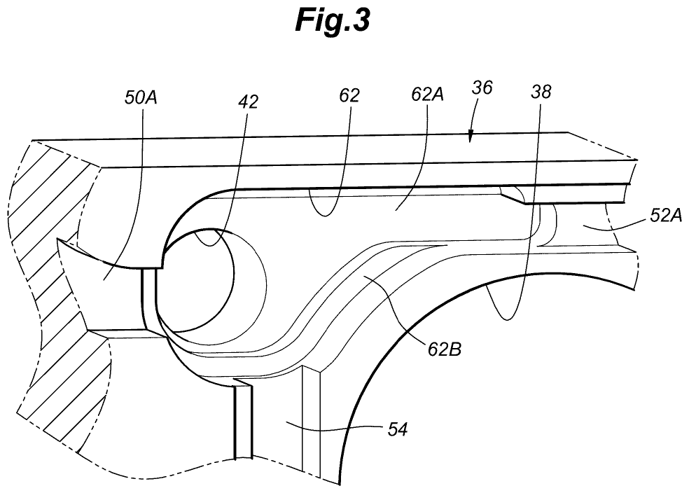

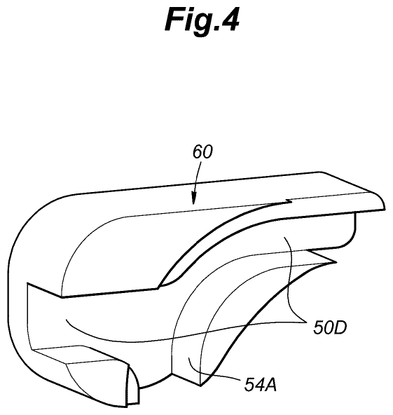

The first passage 48 and the leftward extending part 50A of the left second passage 50 include parts that overlap each other in front and in back in the axial direction. These parts of the first passage 48 and the leftward extending part 50A of the left second passage 50 that overlap each other are separated by a partition wall member 60 (see FIG. 4) to make individual passages, where the partition wall member 60 is fitted in and attached to a recess 62 (see FIG. 3) formed in the ball return member 36.

Details of this separation structure are described. As shown in FIG. 3, the recess 62 of the ball return member 36 has a deep bottom surface 62A in which the lubricating oil injection passage 42 opens and a shallow bottom surface 62B formed on a part of the outer circumference of the deep bottom surface 62A. The partition wall member 60 contacts the shallow bottom surface 62B and defines the first passage 48 between the back side of the partition wall member 60 and the deep bottom surface 62A. The recess 62 formed by the deep bottom surface 62A includes a part that extends rightward beyond the branch position B (see FIG. 5), and the first passage 48 also extends in the same direction. The partition wall member 60 has a lateral dimension such that the right end does not extend beyond the branch position B, and thus, the first passage 48 opens, at the branch position B, toward the base ends of the left second passage 50 and the right second passage 52.

As shown in FIG. 4, the part of the leftward extending part 50A of the left second passage 50 that overlaps the first passage 48 is constituted of a recessed groove 50D formed in the front side of the partition wall member 60. The front side of the partition wall member 60 is formed with a recessed groove 54A that forms a branch end of the left third passage 54 that branches from the left second passage 50.

Due to this configuration, the parts of the first passage 48 and the leftward extending part 50A of the left second passage 50 that overlap each other in the axial direction do not interfere with each other. Moreover, formation of the parts of the first passage 48 and the leftward extending part 50A of the left second passage 50 that overlap each other in the axial direction lap becomes easy without use of a special method.

The left second passage 50, the right second passage 52, the left third passage 54, the right third passage 56, and the fourth passage 58 cooperatively include a part surrounding a radially outer side part of the through hole 38. As shown in FIG. 2, FIG. 5, and FIG. 6, a seal plate 64 for closing the openings, which face the surface of the slider main body 32, of the recessed grooves of the parts of the left second passage 50, the right second passage 52, the left third passage 54, the right third passage 56, and the fourth passage 58 surrounding the through hole 38 is attached to the surface of the ball return member 36 that is joined to the end surface of the slider main body 32. The seal plate 64 has an opening 68 that is substantially coaxial with the through hole 31 (31A, 38) and has an inner diameter smaller than the through hole 31.

Note that the part of the ball return member 36 to which the seal plate 64 is attached is formed with a shelf part 36A (see FIG. 2) having a depth same as the plate thickness of the seal plate 64, and the outer periphery of the seal plate 64 is fitted in the shelf part 36A, whereby the surface of the ball return member 36 that is joined to the end surface of the slider main body 32, including the part of the seal plate 64, forms a continuous plane.

In the above-described configuration, the lubricating oil injected into the lubricating oil injection passage 42 flows through the first passage 48 to the branch position B on the bilateral symmetry line A of the through hole 38, then flows from the branch position B through the left second passage 50 and the right second passage 52 which are bilaterally symmetric, and is supplied to the return passages 40 of the left and right linear ball bearings 70 via the communicating ends 50C, 52C.

The lubricating oil injected into the lubricating oil injection passage 42 first flows to the branch position B via the first passage 48, and a large part thereof flows through the left second passage 50 and the right second passage 52 which are bilaterally symmetric and is supplied to the return passages 40 of the left and right linear ball bearings 70. Therefore, even though the lubricating oil injection passage 42 is offset to one side in the left-right direction with respect to the branch position B, the lubricating oil from the lubricating oil injection passage 42 is supplied evenly to the return passages 40 of the left and right linear ball bearings 70.

In other words, the left second passage 50 and the right second passage 52 are bilaterally symmetric with respect to the bilateral symmetry line A and the passage lengths thereof are the same as each other, and thus, even though the lubricating oil injection passage 42 is offset to one side in the left-right direction with respect to the branch position B, the left and right linear ball bearings 70 are evenly lubricated by the lubricating oil.

Since the lubricating oil injection passage 42 is offset to one side in the left-right direction with respect to the branch position B, the spacing between the upper edge of the through hole 31 (31A, 38) of the slider 30 including the ball return members 36 and the upper edge (upper surface) of the slider 30 can be reduced compared to the case where the lubricating oil injection passage 42 is on the branch position B. Accordingly, the height dimension H (see FIG. 5) of the slider 30 can be reduced, and hence, the ball screw actuator 10 can be downsized in the up-down direction.

Of the outer end portion 40A and the inner end portion 40B of the return passage 40, the outer end portion 40A is provided on a side closest to the air gap G of the external passage 74 and opened to the atmosphere, whereby the lubricating oil pressure in the outer end portion 40A becomes lower than the lubricating oil pressure in the inner end portion 40B. In other words, regarding the lubricating oil pressure in the return passage 40, the side on the outer end portion 40A becomes a lower pressure side compared to the side on the inner end portion 40B.

The communicating ends 50C, 52C of the left second passage 50 and the right second passage 52 for the corresponding return passages 40 are each in communication with a part of the return passage 40 on the side closer to the outer end portion 40A than a position where the return passage 40 is bisected between the inner end portion 40B and the outer end portion 40A. Due to this structure of the left second passage 50 and the right second passage 52, the lubricating oil is supplied to each return passage 40 on the lower pressure side where the lubricating oil pressure (internal pressure) is lower than in the inner end portion 40B.

Thereby, compared to the case where the lubricating oil is supplied to the return passage 40 on the side of the inner end portion 40B, the lubricating oil is smoothly supplied to the return passage 40 without increasing the injection pressure of the lubricating oil, and the supply workability of the lubricating oil is improved.

Since the internal pressure of the lubricating oil in the return passage 40 becomes the lowest in the outer end portion 40A which is closest to the air gap G of the external passage 74, it is preferable that, as shown by virtual lines in FIG. 5, each communicating end 50C, 52C is in communication with the outer end portion 40A for smooth supply of the lubricating oil to the return passage 40.

Since the communicating ends 50C, 52C of the left second passage 50 and the right second passage 52 for the corresponding return passages 40 are each in communication with a part of the return passage 40 on the side closer to the outer end portion 40A than a position where the return passage 40 is bisected between the inner end portion 40B and the outer end portion 40A, the lubricating oil is supplied to the return passage 40 at a part where the lubricating oil pressure (internal pressure) is lower than in the inner end portion 40B.

Thereby, compared to the case where the lubricating oil is supplied to the return passage 40 on the side of the inner end portion 40B, the lubricating oil is smoothly supplied to the return passage 40 without increasing the injection pressure, and the supply workability of the lubricating oil is improved.

As shown by virtual lines in FIG. 5, it is preferable that each communicating end 50C, 52C is in communication with the outer end portion 40A which is closest to the air gap G of the corresponding external passage 74 for smooth supply of the lubricating oil related to the aforementioned internal pressure.

Part of the lubricating oil injected into the lubricating oil injection passage 42 first flows to the branch position B via the first passage 48, thereafter flows through the left second passage 50, the right second passage 52, the left third passage 54, the right third passage 56, and the fourth passage 58, and flows out from the open end 58A to the through hole 38.

Thereby, the lubricating oil is applied to the outer circumferential surface of a part of the ball screw shaft 102 penetrating through the through hole 38, and the ball screw shaft 102 is lubricated.

As shown in FIG. 6, since the inner diameter of the opening 68 of the seal plate 64 is smaller than the inner diameter of the through hole 31A of the slider 30, the seal plate 64 acts as a barrier that separates the through hole 31A and the through hole 38 as shown in FIG. 6, whereby it becomes difficult for the lubricating oil flowing out from the open end 58A of the fourth passage 58 to the through hole 38 to flow to the through hole 31A. In other words, the lubricating oil supplied to the through hole 38 of the ball return member 36 is prevented from excessively flowing to the slider main body 32. Thereby, it becomes difficult for the lubricating oil to flow to the ball screw nut part 100 in the slider main body 32 more than necessary, and unnecessary consumption of the lubricating oil is reduced.

### Embodiment 2

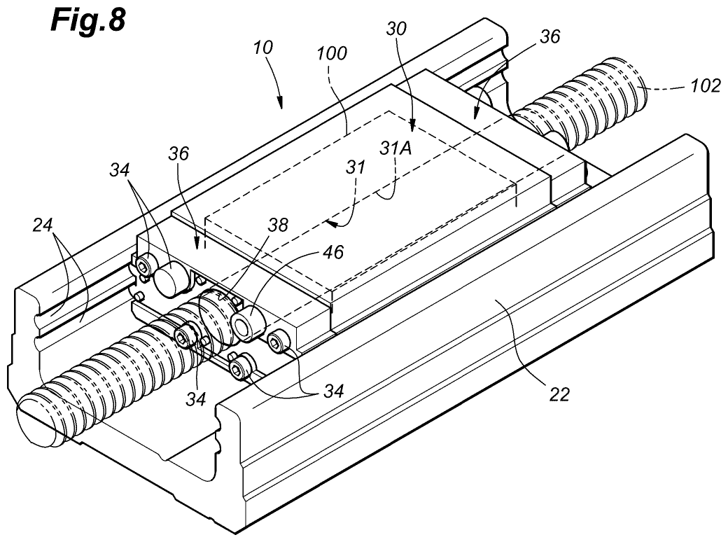

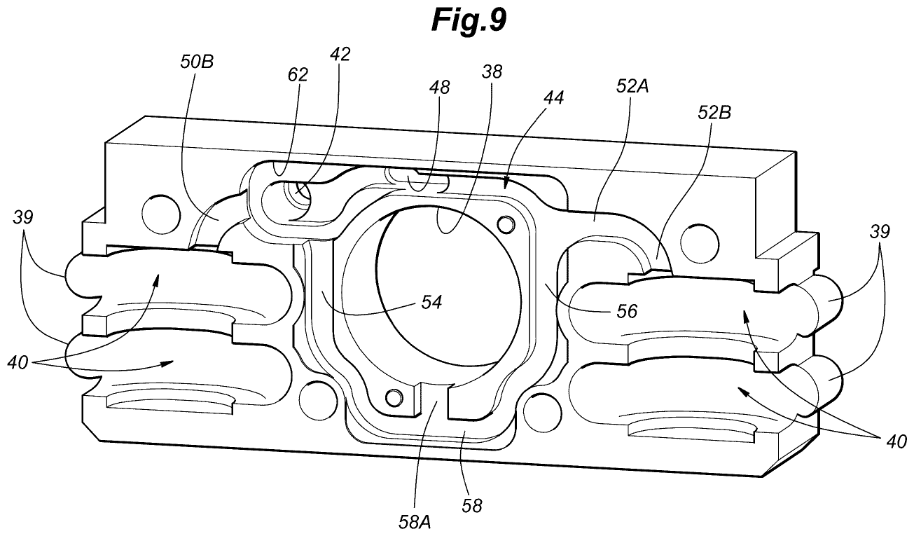

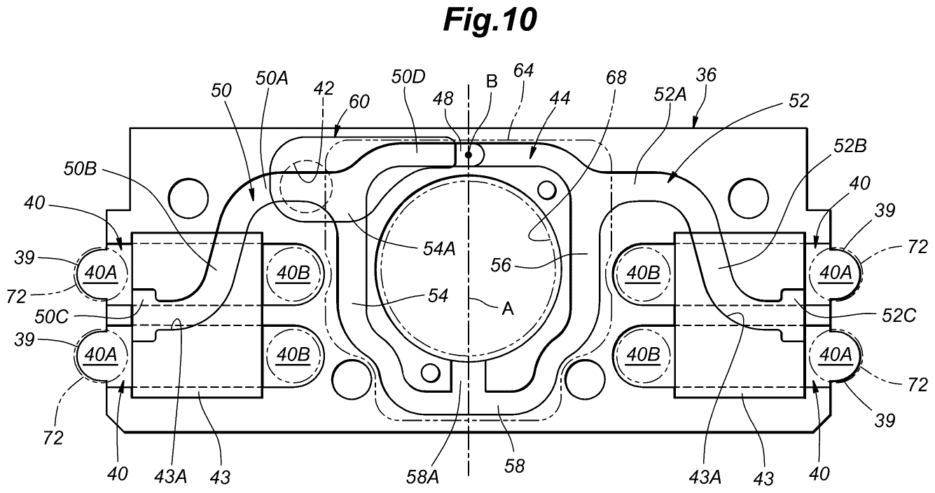

With reference to FIG. 8 to FIG. 10, a ball screw actuator 10 of Embodiment 2 will be described. Note that in FIG. 8 to FIG. 10, parts corresponding to those of FIG. 1 to FIG. 9 are denoted by the same reference signs as in FIG. 1 to FIG. 9, and the description thereof is omitted.

In the ball screw actuator 10 of Embodiment 2, each of the left and right linear ball bearings 70 is configured in two stages, an upper stage and a lower stage. Each ball return member 36 includes the return passages 40 arranged in two stages, an upper stage and a lower stage. The inclined extending part 50B of the left second passage 50 and the inclined extending part 52B of the right second passage 52, each including a part defined by the recessed groove 43A formed by the corresponding passage defining member 43, are formed bilaterally symmetrically to extend to between the return passages 40 arranged in the upper stage and the lower stage, and are in communication with each of the upper and lower return passages 40 via respective communicating ends 50C, 52C, each of which is up-down symmetric and opens outward.

The passage defining member 43 extends to vertically straddle the return passages 40 arranged in the upper stage and the lower stage, and collectively defines the return passages arranged in the upper stage and the lower stage each including the outer end portion 40A and the inner end portion 40B.

The communicating ends 50C, 52C of the inclined extending part 50B of the left second passage 50 and the inclined extending part 52B of the right second passage 52 each open outward toward the return passages 40 arranged in the upper stage and the lower stage from a part of the passage defining member 43 located between the return passages 40 arranged in the upper stage and the lower stage.

In Embodiment 2 also, the lubricating oil injected into the lubricating oil injection passage 42 flows through the first passage 48 to the branch position B on the bilateral symmetry line A of the through hole 38, flows from the branch position B through the left second passage 50 and the right second passage 52 which are bilaterally symmetric, and is supplied to each return passage 40 of the left and right linear ball bearings 70 arranged in the upper stage and the lower stage from the communicating ends 50C, 52C, each of which is up-down symmetric with respect to the return passages 40 arranged in the upper stage and the lower stage.

Thereby, even though the lubricating oil injection passage 42 is offset to one side in the left-right direction with respect to the branch position B, supply of the lubricating oil to the left and right linear ball bearings 70 arranged in the upper stage and the lower stage is performed evenly between up and down and between left and right.

A part of each of the inclined extending part 50B of the left second passage 50 and the inclined extending part 52B of the right second passage 52, specifically, a part of each of the inclined extending part 50B and the inclined extending part 52B that vertically crosses the upper return passage 40 is formed by the recessed groove 43A formed in the passage defining member 43, and thus, the configuration of the inclined extending part 50B and the inclined extending part 52B does not become complicated and the formation thereof is easy.

In the foregoing, the present invention has been described in terms of preferred embodiments thereof, but as can be readily appreciated by a person of ordinary skill in the art, the present invention is not limited to such embodiments and may be modified appropriately within the scope not departing from the spirit of the present invention.

For example, the partition wall that separates the portions of the first passage 48 and the leftward extending part 50A of the left second passage 50 that overlap each other in front and in back in the axial direction does not have to be the partition wall member 60 but may be integrally formed in the ball return member 36 by molding or the like. The lubricating oil supply structure for the linear ball bearing 70 including the lubricating oil supply passage 44 does not necessarily have to be configured in each of the ball return members 36 at the both ends of the slider main body 32 in the axial direction, and may be configured in only one of the ball return members 36 at the both ends.

The lubricating oil supply structure for the linear ball bearings 70 which includes the first passage 48, the left second passage 50, the right second passage 52, etc. is not limited to application to the linear ball bearings 70 of the slider 30 of the ball screw actuator 10, but may be applied to the lubricating oil supply structure for the pair of left and right linear ball bearings 70 of any linear guide device in which the slider 30 is driven by a linear motor or the like, other than the ball screw actuator 10.

Also, not all of the components shown in the above embodiments are necessarily indispensable and they may be selectively adopted as appropriate so long as not departing from the spirit of the present invention.

### LIST OF REFERENCE NUMERALS

10: ball screw actuator
20: guide rail
22: side wall
24: recessed groove
30: slider
31: through hole
31A: through hole
32: slider main body
34: bolt
36: ball return member
36A: shelf part
38: through hole
39: ball fall-off preventing part
40: return passage
40A: outer end portion
40B: inner end portion
41: recessed groove
42: lubricating oil injection passage
43: passage defining member
43A: recessed groove
44: lubricating oil supply passage
46: lubricating oil nipple
48: first passage
50: left second passage
50A: leftward extending part
50B: inclined extending part
50C: communicating end
50D: recessed groove
52: right second passage
52A: rightward extending part
52B: inclined extending part
52C: communicating end
54: left third passage
54A: recessed groove
56: right third passage
58: fourth passage
58A: open end
60: partition wall member
62: recess
62A: deep bottom surface
62B: shallow bottom surface
64: seal plate
68: opening
70: linear ball bearing
72: ball
74: external passage
76: internal passage
100: ball screw nut part
102: ball screw shaft
104: ball
A: bilateral symmetry line
B: branch position
G: air gap

1. A ball screw actuator, comprising:
a linear guide rail comprising left and right side walls and defining a concave cross-sectional shape;
a slider disposed between the left and right side walls of the guide rail;
left and right linear ball bearings which are provided with multiple balls that circulate between the slider and the left and right side walls of the guide rail, and which guide movement of the slider in an axial direction relative to the guide rail;
a ball screw nut part provided in the slider; and
a ball screw shaft that passes through a through hole provided in the slider in the axial direction and is threadedly engaged with the ball screw nut part provided in the slider via balls,
wherein the slider comprises a slider main body comprising a ball screw nut part, and ball return members respectively attached to both ends of the slider main body in the axial direction,
at least one of the ball return members comprises left and right return passages through which each ball of the left and right linear ball bearings moves, the left and right linear ball bearings being provided bilaterally symmetrically with respect to the through hole, a lubricating oil injection passage provided offset to one of left and right sides with respect to the through hole, and a lubricating oil supply passage for supplying lubricating oil from the lubricating oil injection passage to the left and right return passages, and
the lubricating oil supply passage comprises a first passage that extends from the lubricating oil injection passage to a branch position on a bilateral symmetry line which passes through a center of the through hole, and second passages which are branched left and right from the branch position to respectively extend to the left and right return passages and are bilaterally symmetric.

2. The ball screw actuator according to claim 1, wherein each of the left and right linear ball bearings comprises an external passage formed between a corresponding one of the side walls of the guide rail and the slider main body and an internal passage formed to extend in the axial direction inside the slider main body,
each of the left and right return passages comprises an outer end portion communicating with the corresponding external passage and an inner end portion communicating with the corresponding internal passage, and
the second passages respectively communicate with parts of the left and right return passages on a side closer to the outer end portion than to the inner end portion.

3. The ball screw actuator according to claim 2, wherein the second passages respectively communicate with the outer end portions of the left and right return passages.

4. The ball screw actuator according to claim 1, wherein the first passage and the second passage comprise parts that overlap each other in front and in back in the axial direction, and the first passage and the second passage at the parts that overlap each other are separated by a partition wall provided on the ball return member.

5. The ball screw actuator according to claim 4, wherein the partition wall is constituted of a partition wall member attached to the ball return member.

6. The ball screw actuator according to claim 1, wherein the lubricating oil supply passage further comprises third passages extending from the respective second passages bilaterally symmetrically on a radially outer side of the through hole, and a fourth passage extending from the third passages to the through hole.

7. The ball screw actuator according to claim 6, wherein the first passage, the second passages, the third passages, and the fourth passage comprise parts constituted of recessed grooves opening in a surface of the ball return member that contacts an end surface of the slider main body, and
the recessed grooves define the lubricating oil supply passage with an opening being closed by the end surface of the slider main body.

8. The ball screw actuator according to claim 7, wherein the first passage and the second passage further comprise parts that overlap each other in front and in back in the axial direction, and the first passage and the second passage at the parts that overlap each other are separated by a partition wall member attached to the ball return member, the part of the second passage overlapping the first passage being constituted of a recessed groove provided in the partition wall member.

9. The ball screw actuator according to claim 6, further comprising a seal plate disposed between the slider main body and each of the ball return members, wherein each of the seal plates comprises an opening with an inner diameter smaller than the through hole.

10. The ball screw actuator according to claim 1, wherein each of the left and right linear ball bearings is configured in two stages, an upper stage and a lower stage, the ball return member further comprises the return passages arranged in two stages, an upper stage and a lower stage, and the second passages extend bilaterally symmetrically to between the return passages arranged in the upper stage and the lower stage and are in communication with the return passages arranged in the upper stage and the lower stage.
